(19) United States
(12) Patent Application Publication
(10) Pub. No.: US 2008/0051084 A1
(43) Pub. Date: Feb. 28, 2008

(54) Telecommunications system and method for early transmission of data

(76) Inventors: Alessio Casati, Swindon (GB); Sudeep Kumar Palat, Grange Park (GB); Said Tatesh, Swindon (GB)

Correspondence Address: Lucent Technologies Inc.;Docket Administrator - Room 3J-219, 101 Crawfords Corner Road, Holmdel, NJ, 07733-3030, US

(21) Appl. No.: 11/508,352

(22) Filed: Aug. 23, 2006

(51) Int. Cl. H04Q 7/20

(52) U.S. Cl. 455/435.1

(57) ABSTRACT

In a telecommunications system, such as E-UTRAN, a User Equipment 6 is connected to a base station eNB 8 by an early radio bearer, which is established using preset values stored at the UE 6 and at the eNB 8. This enables data to be transferred over the radio link prior to formal establishment of a radio bearer between the UE 6 and the eNB 8.

### FIELD OF THE INVENTION

The present invention relates to a telecommunications system and method for early transmission of data in a telecommunications system, and more particularly, but not exclusively, to a telecommunications system and method implemented in accordance with the evolved Universal Terrestrial Radio Access Network (E-UTRAN) and evolved Universal Terrestrial Radio Access (E-UTRA) standards.

### BACKGROUND OF THE INVENTION

One of the identified drawbacks of Universal Terrestrial Radio Access Network (UMTS) is the latency and delay associated with establishing the radio bearers across which data is transferred. This limitation of UMTS has been the cause of poorer performance for applications like Push to Talk over Cellular (PoC) compared to General Packet Radio Service (GPRS). In UMTS, an initial Radio Resource Control (RRC) procedure must be complete before Non-Access Stratum (NAS) procedures can be executed. Then, the Radio Access Bearer (RAB) establishment procedures must be completed before any application data including Session Initiation Protocol (SIP) signalling can occur. Various solutions have been proposed to reduce the latencies in UMTS, but these tend to be complex.

Currently, the Third Generation Partnership Project (3GPP) is considering development of evolved Universal Terrestrial Radio Access (E-UTRA) and evolved Universal Terrestrial Radio Access Network (E-UTRAN) as set out in 3GPP TR 25.912 V7.0.0 (2006-06) Technical Report 3rd Generation Partnership Project; Technical Specification Group, Radio Access Network; (Release 7), incorporated herein by reference, and related documents. FIG. 1 schematically illustrates the E-UTRAN architecture. User Equipment (UE) 1 communicates with an E-UTRAN NodeB (eNB) 2, with data being sent on radio bearers (RBs) over a radio link 3 between them. The eNB 3 interfaces with an Access Gateway (aGW) 4 via an interface designated as S1. In practice, of course, there are a plurality of eNBs and aGWs included in an E-UTRAN system. As presently envisaged by the 3GPP, the functions hosted by the eNB are: selection of aGW at attachment; routing towards aGW at RRC activation; scheduling and transmission of paging messages; scheduling and transmission of Broadcast Control Channel (BCCH) information; dynamic allocation of resources to UEs in both uplink and downlink; the configuration and provision of eNB measurements; radio bearer control; radio admission control; and Connection Mobility Control in the LTE_ACTIVE state. Those functions hosted by the aGW are envisaged to be: paging origination; LTE_IDLE state management; ciphering of the User plane (U-plane); Packet Data Convergence Protocol (PDCP) System Architecture Evolution (SAE) Bearer Control; and ciphering and integrity protection of Non-Access Stratum (NAS) signalling.

FIG. 2 illustrates the messaging required for transmission of data between the UE 1 and the aGW 4. The messaging is used in establishing an RB between the UE 1 and the eNB 2, and an access bearer between the eNB 2 and the aGW 4, the latter including a Mobile Management Entity (MME) 5. The delays and messaging involved during the establishment of a data communication path are denoted in FIG. 2 by numbered steps from Step 1: “Delay for RACH scheduling period” to Step 16: “H-ARQ Retransmission”, and the steps sequentially occur in the order shown. Thus, for example, following the transmission of Random Access Channel (RACH) Preamble from UE 1 to eNB 2 at Step 2, there is a processing delay experienced at the eNB 2, as shown at Step 3, and so on. Other abbreviations used in FIG. 2 are Tracking Area (TA) and Hybrid Automatic Repeat Request (H-ARQ).

The integration of the radio network controller (RNC) function with the eNB in E-UTRAN, these being separately provided in UMTS, and the avoidance of dedicated channels and soft handover, should provide significant performance benefits in terms of signalling delay. However, it has been realized that, if it is possible to transmit some data prior to the signalling for the establishment of a radio bearer between a UE and eNB, then latency will be reduced. This can be done securely provided the UE has previously Attached to the network and a security context has been established in the aGW and the UE. This concept is referred to as “Early radio bearer establishment”. Assuming an average S1 delay of 5 ms, say, the savings from Early RB establishment can be estimated to be 29 ms, compared with a total delay estimate of 49 ms (for the same 5 ms S1 delay), leading to a saving of about 60%. One way to achieve early RB establishment could be by using a “default” RB which is assumed to be established at the time of the attach, but any proposal must not introduce excessive complexity or security issues and does not provide the same flexibility in terms on which RB the UE can send data on.

Additionally, the UE may have multiple RBs and it must be possible to identify which RB the data belongs to. Normally, a Tunnel Endpoint Identifier (TEID) field is included in the data packets sent over the S1 interface to identify the RB. The TEID for each RB is negotiated by signalling between the eNB and aGW. With Early RB establishment, this signalling will not completed at the time the uplink packet arrives in the eNB to be sent to the aGW. The Early radio bearer establishment procedure must also provide a means to identify the RB that the packet belongs to at the aGW.

### BRIEF SUMMARY OF THE INVENTION

According to one aspect of the invention, a method of transmission of data in a telecommunications system, includes the steps of: providing pre-set values, associated with an early radio bearer, at a user equipment and at a base station; and the user equipment and the base station each autonomously configuring an early radio bearer between them using the pre-set values, such that data can be transmitted between the user equipment to the base station using the early radio bearer. The configuration by the user equipment and base station may be carried out immediately following an initial signaling exchange for the RRC connection establishment.

While the invention is particularly applicable to E-UTRAN and E-UTRA, it may also be applicable to wireless systems based on other standards in which data is sent over radio bearers and in which early transmission of data is sought. In the context of E-UTRAN, the base station is an eNB.

The invention enables a default RB to be set up to permit early transmission of data, without excessive additional complexity.

The method may include downloading user equipment context from a core network and then re-configuring the established early radio bearer using the values received in the user equipment context. The core network may be represented by an aGW in an E-UTRAN system, for example.

In addition to providing radio bearer configuration information, transport parameters for transmission of data over the S1 interface are also required to be available at the eNB to transport data to the aGW. Typically, the parameters involved are the User Plane Entity (UPE) IP address, UDP port number and Tunnel Endpoint Identifier (TEID). The UPE address may be provided by the UE. For example, a temporary UE id may be mapped on to a UPE address as is done for the control plane in Iu-flex systems. Also, in one method in accordance with the invention, a UDP port at the eNB is preconfigured to act as an early radio bearer UDP port.

There are several ways for dealing with the need for the TEID at the eNB. For example, in one method in accordance with the invention, a data packet transmitted over the early radio bearer is buffered at the eNB until the TEID is supplied from the aGW. Another method uses a default TEID with an additional logical channel ID field in the header. In other methods, there is a static specified mapping between the logical channel ID and the TEID, or even parts of the TEID, to allow the UPE to identify the logical channel that packet belongs to. This is a temporary association. Yet another method includes logical flow information in the PDCP header for those instances were the packet is sent before the radio bearer is established. One such method may be provided, or a combination of them may be used.

In another aspect of the invention, a telecommunications system comprises at least one base station and user equipment, the base station including a store for storing preset values, associated with an early radio bearer, the user equipment including a store for storing preset values, associated with an early radio bearer, and means for each of the user equipment and the base station to autonomously configure an early radio bearer between them using the stored pre-set values. The system may be one that is in accordance with the E-UTRAN standard, the base station being an eNB.

In another aspect of the invention, a user equipment comprises a store for storing preset values associated with establishing an early radio bearer in a telecommunication system.

### BRIEF DESCRIPTION OF THE DRAWINGS

Some methods and embodiments of the present invention will now be described by way of example only, and with reference to the accompanying drawings, in which:

FIG. 1 schematically illustrates E-UTRAN architecture;

FIG. 2 schematically illustrates messaging associated with an E-UTRAN system;

FIGS. 3 and 4 schematically illustrate a method and E-UTRAN system in accordance with the invention;

FIG. 5 schematically illustrates messaging associated with an E-UTRAN system in accordance with the invention; and

FIGS. 6 to 9 schematically illustrate alternatives.

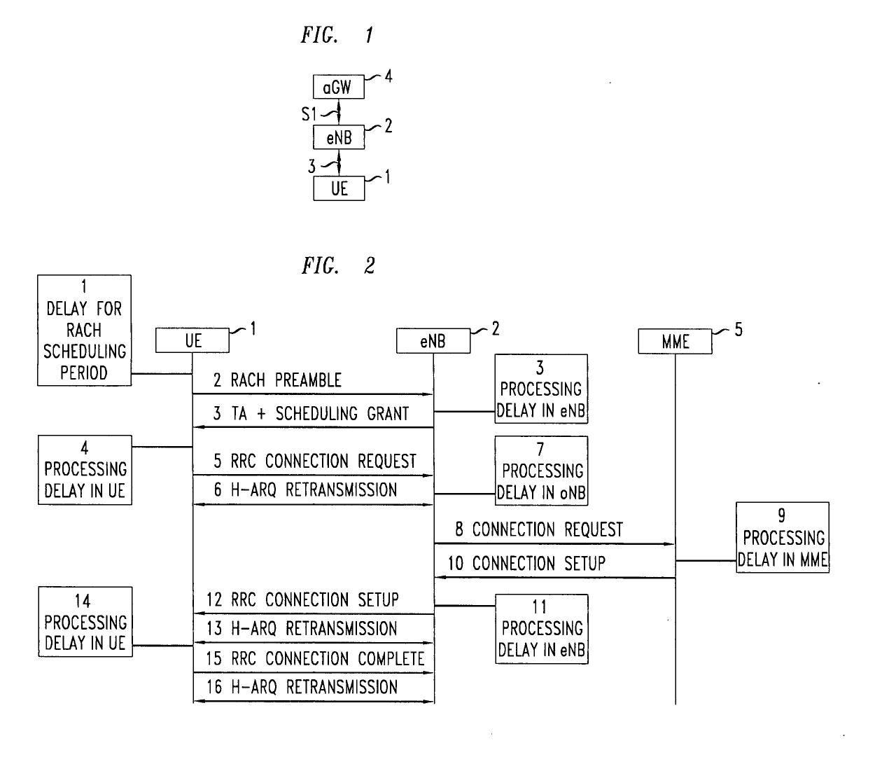

### DETAILED DESCRIPTION OF THE DRAWINGS

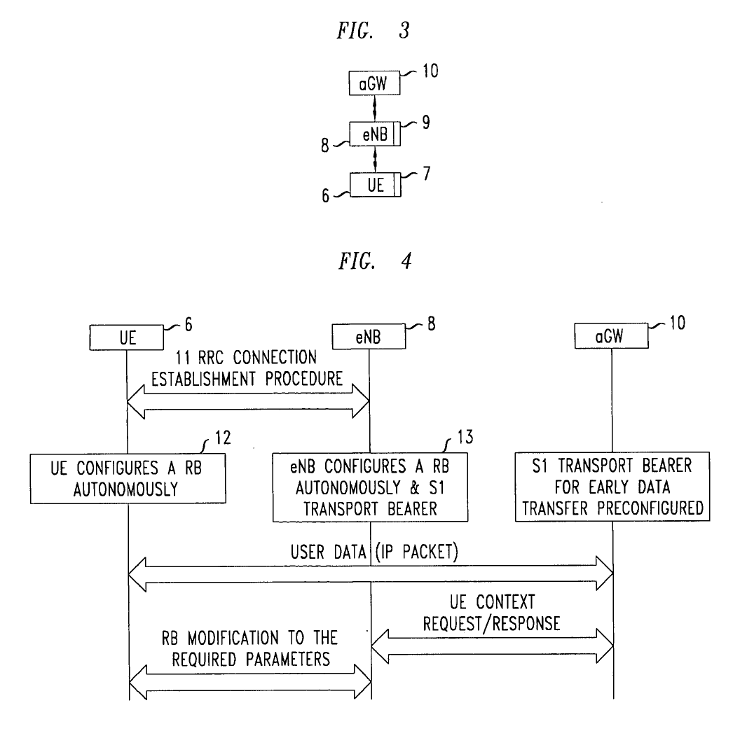

With reference to FIGS. 3 and 4, a UE 6 includes a store 9 in which are stored preset values relating to the Quality of Service, Medium Access Control, (MAC), and Radio Link Control (RLC). Similarly, an eNB 8 has a store 9 that stores preset values for the same parameters. The aGW stores the security context.

When the UE 6 wishes to connect to a core network, represented by an aGW 10, certain initial signaling takes place, as shown at 11 on FIG. 4 to alert the eNB 8 and enable a signaling connection to be set up between the UE and eNB. Following this, both the UE 6 and the eNB 8 separately and independently access their stored values held at stores 7 and 9 respectively as shown at 12 and 13 to enable an RB to be established between them, this RB being an Early RB.

In addition the S1 transport bearer between the eNB 8 and the aGW 10 is configured. In this method, the required data is already stored at the aGW 10, as stored preset values. The data stored in the eNB does not include user specific information like the TEID to be used for each RB. User data is transmitted between the UE 6 and eNB 8, and between the eNB 8 and the aGW 10, as shown at 14.

Following the Early RB establishment, modification is required to the RB parameters to the more specific RB conditions most appropriate for that data flow, available once the messaging is complete to enable such an RB to be formally established.

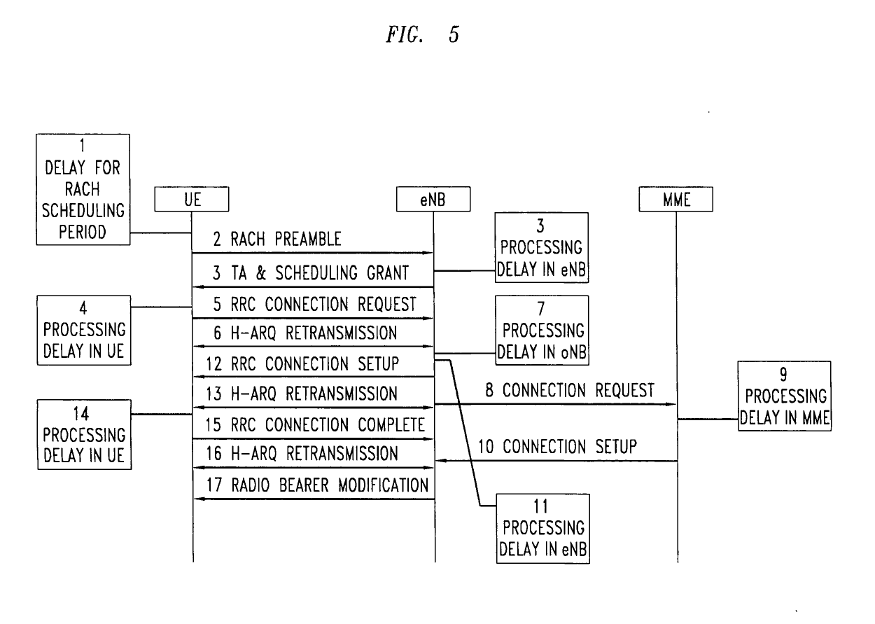

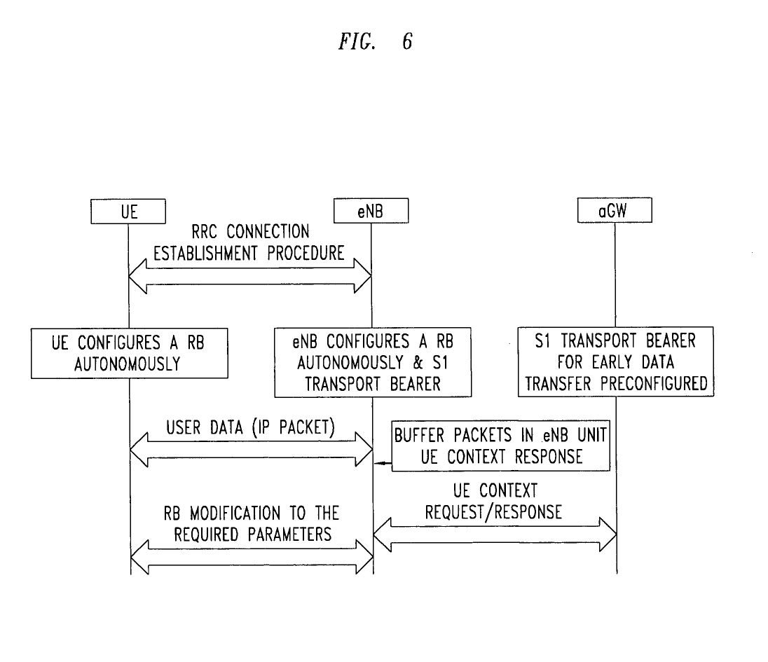

FIG. 5 illustrates the messaging associated with the arrangement illustrated in FIG. 4, with Steps being given the same numbering as that shown in FIG. 2. It can be seen from this that the order of the steps is now different, for example Step 10 occurs after Steps 15 and 16. By deferring some of the steps relative to others, overall delays in the system may be reduced compared to the FIG. 2 message flow.

Data packets sent on the early radio bearer are encrypted with encryption including a sequence number associated with a data packet. The sequence number is also used to discard duplicated packets.

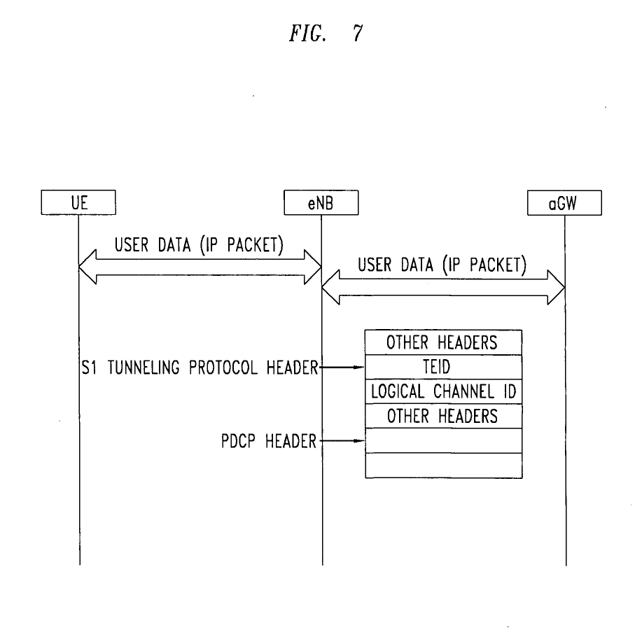

Several alternative solutions to identify the RB of the packet are shown in FIGS. 6 to 9. An alternative to the Early establishment of the S1 interface is shown in FIG. 6. In this case, packets are buffered in the eNB until the UE context response from the aGW 10 is received.

FIG. 7 illustrates another approach to identify the RB that the packet belong to, in which an additional header element is used to identify the logical channel in addition to the Tunnel Endpoint Identifier (TEID) over the eNB to aGW S1 interface.

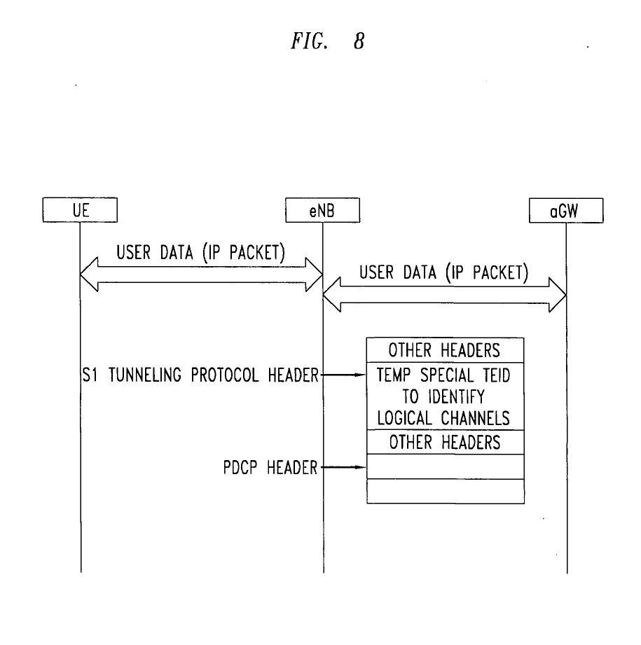

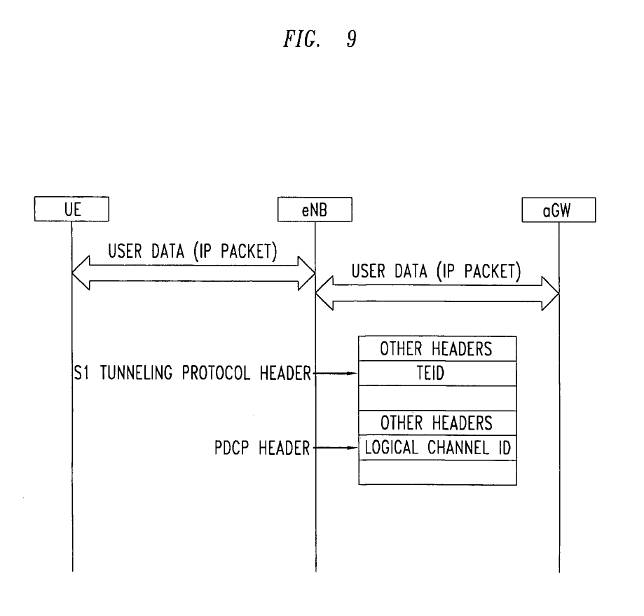

FIG. 8 shows another method, in which special values of TEID are preconfigured to identify the logical channel exclusively for the Early data bearer. This is a temporary assignment and released as soon as the proper bearer is established. Thus, only a small number of preconfigured values are required. The TEID is subsequently reconfigured to the correct one to identify the logical channel of the real bear established subsequently.

Finally, in FIG. 9, another method is such that the logical channel Id is included in the PDCP header provided by the UE.

The present invention may be embodied in other specific forms, and implemented by other methods, without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of transmission of data in a telecommunications system, including the steps of: providing pre-set values, associated with an early radio bearer, at a user equipment and at a base station; and the user equipment and the base station each autonomously configuring an early radio bearer between them using the pre-set values, such that data can be transmitted between the user equipment to the base station using the early radio bearer.

2. The method as claimed in claim 1 and wherein the preset values include values associated with at least one of: the Quality of Service; Medium Access Control, MAC; and Radio Link Control, RLC.

3. The method as claimed in claim 1 and wherein the configuration by the user equipment and base station is carried out immediately following an initial signaling exchange for the RRC connection establishment.

4. The method as claimed in claim 1 and including downloading user equipment context from a core network and then re-configuring the established early radio bearer using the values received in the user equipment context.

5. The method as claimed in claim 1 and wherein a data packet transmitted over the early radio bearer is buffered at the base station until the Tunnel Endpoint Identifier, TEID, is supplied from a core network to the base station for establishing an interface between them.

6. The method as claimed in claim 1 and wherein a default TEID with an additional logical channel ID field is stored at and included in each packet by the base station.

7. The method as claimed in claim 1 and wherein a static specified mapping is provided between the logical channel ID and at least parts of the TEID such that the User Plane Entity, UPE, is able to identify the logical channel that a data packet belongs to.

8. The method as claimed in claim 1 and including logical flow information in the Packet Data Convergence Protocol, PDCP, header.

9. The method as claimed in claim 1 and including encrypting data packets sent on the early radio bearer with encryption including a sequence number associated with a data packet and using the sequence number to discard duplicated packets.

10. The method as claimed in claim 1 and including a UDP port at the base station, the UDP port being preconfigured to act as an early radio bearer UDP port.

11. The method as claimed in claim 1 and implemented in an E-UTRAN system.

12. A telecommunications system comprising at least one base station and user equipment, the base station including a store for storing preset values, associated with an early radio bearer, the user equipment including a store for storing preset values, associated with an early radio bearer, and means for each of the user equipment and the base station to autonomously configure an early radio bearer between them using the stored pre-set values.

13. The system as claimed in claim 12 and in accordance with the E-UTRAN standard, the base station being an eNB.

14. A user equipment comprising a store for storing preset values associated with establishing an early radio bearer in a telecommunication system.
